(19) United States
(12) Patent Application Publication
(10) Pub. No.: US 2025/0201892 A1
(43) Pub. Date: Jun. 19, 2025

(54) Device and Method for Manufacturing Secondary Battery

(71) Applicant: LG Energy Solution, Ltd., Seoul (KR)

(72) Inventors: Hyung Jun Noh, Daejeon (KR); Hyun Tae Kim, Daejeon (KR); Young Soon Kim, Daejeon (KR)

(73) Assignee: LG Energy Solution, Ltd., Seoul (KR)

(21) Appl. No.: 18/701,686

(22) PCT Filed: Dec. 2, 2022
(86) PCT No.: PCT/KR2022/019483

§ 371 Date: Apr. 16, 2024

(30) Foreign Application Priority Data
Dec. 20, 2021 (KR) 10-2021-0183211

(51) Int. Cl. H01M 10/04; H01M 50/105; H01M 50/198

(52) U.S. Cl. CPC H01M 10/0404; H01M 10/0481; H01M 50/105; H01M 50/198

(57) ABSTRACT

A device for manufacturing a secondary battery includes: a pair of sealing blocks that are disposed at both sides, respectively, of a sealing part of a pouch from which an electrode lead is drawn out, the pair of sealing blocks being configured to compress and seal the sealing part at a seal temperature and pressure; and a preheating member that preheats each of the sealing part of the pouch and the pair of sealing blocks to a preheat temperature. The preheating member includes a first heating body that preheats to the preheat temperature a surface of the sealing part, on which each of the pair of sealing blocks is disposed, and a second heating body that preheats to the preheat temperature a surface of each of the pair of sealing blocks, which faces the sealing part.

### CROSS-REFERENCE TO RELATED APPLICATIONS

The present application is a national phase entry under 35 U.S.C. § 371 of International Application No. PCT/KR2022/019483, filed on Dec. 2, 2022, which claims priority from Korean Patent Application No. 10-2021-0183211, filed on Dec. 20, 2021, all of which are incorporated herein by reference.

### TECHNICAL FIELD

The present disclosure relates to a device and method for manufacturing a secondary battery, which is capable of improving sealing force of a sealing part of a pouch from which an electrode lead is drawn out.

### BACKGROUND ART

In general, secondary batteries refer to batteries, which are chargeable and dischargeable unlike non-rechargeable primary batteries, and are widely used in electronic devices such as mobile phones, notebook computers and camcorders, electric vehicles, or the like.

Such secondary batteries include an electrode assembly provided with an electrode tab, an electrode lead coupled to the electrode tab, a pouch that accommodates the electrode assembly with a front end of the electrode lead drawn out to the outside thereof, and a lead film provided in the electrode lead disposed on a sealing part of the pouch. The pouch includes an accommodation part that accommodates the electrode assembly, and the sealing part that is formed along an edge surface of the accommodation part and seals the accommodation part.

A method for manufacturing a secondary battery may include an accommodating process of accommodating an electrode assembly in an accommodation part of a pouch, and a sealing process of sealing a sealing part of the pouch using a pair of sealing blocks. In the sealing process, the sealing part of the pouch may be sealed by raising a temperature of the pair of sealing blocks to apply heat to the sealing part.

Here, as a lead film and the sealing part are thermally fused to each other, the sealing part of the pouch from which an electrode lead is drawn out is sealed. Then, there is a problem that the sealing force is reduced because of a heat loss through the electrode lead made of a metal material.

In order to solve such a problem, a lead heater system is introduced which supplies a heat source to the electrode lead, and accordingly, the heat loss through the electrode lead may be minimized. Consequently, the sealing force of the sealing part may be increased.

Although the sealing process with the introduced lead heater system may minimize the heat loss through the electrode lead because the electrode lead is directly heated, it has a problem that there is a temperature difference in the entire pouch from which the electrode lead is drawn out. Such a problem leads to a problem that there is a sealing force difference in the entire sealing part of the pouch from which the electrode lead is drawn out. In particular, there is a limit to supply of sufficient heat to the electrode lead or the sealing blocks in a short time.

### DISCLOSURE OF THE INVENTION

### Technical Problem

An aspect of the present invention for solving the problems as above may include a preheating member to heat a sealing part of a pouch and a sealing block to a preheat temperature lower than a seal temperature before the sealing part of the pouch is sealed. Accordingly, as an electrode lead is also heated to the preheat temperature together with the sealing part of the pouch, a heat loss through the electrode lead may be minimized. Consequently, sealing force of the sealing part of the pouch from which the electrode lead is drawn out may be increased. In particular, the sealing part of the pouch from which the electrode lead is drawn out may be uniformly heated, and the temperature of the sealing block may be suppressed from decreasing during continuous manufacture. That is, when secondary batteries are continuously sealed through the sealing block, the temperature of a heat source may gradually decrease and accordingly, a difference in sealing force may occur between the secondary batteries produced at the beginning of a sealing process and the secondary batteries produced at each of the middle and the later part of the sealing process. An object of the present invention for preventing the difference is to provide a device and method for manufacturing a secondary battery, which may preheat the sealing block to prevent a decrease in temperature of the heat source of the sealing block and consequently, may maintain the sealing force to be uniform in the overall sealing process.

### Technical Solution

A device for manufacturing a secondary battery according to an aspect of the present invention for achieving the object as above may include: a pair of sealing blocks that are disposed at both sides, respectively, of a sealing part of a pouch, from which an electrode lead is drawn out, and compress and seal the sealing part at a seal temperature and pressure; and a preheating member that preheats each of the sealing part of the pouch and the pair of sealing blocks to a preheat temperature. The preheating member may include: a first heating body that preheats a surface of the sealing part, on which each of the pair of sealing blocks is disposed, to the preheat temperature; and a second heating body that preheats a surface of each of the pair of sealing blocks, which faces the sealing part, to the preheat temperature.

The preheat temperature of the sealing part preheated by the first heating body and the preheat temperature of the pair of sealing blocks preheated by the second heating body may be the same as or different from each other.

When the preheat temperature of the sealing part preheated by the first heating body and the preheat temperature of the pair of sealing blocks preheated by the second heating body are different from each other, the preheat temperature of the sealing part preheated by the first heating body may be lower than the preheat temperature of the pair of sealing blocks preheated by the second heating body.

The preheat temperature may be set to 100° C. to 230° C.

Each of the first heating body and the second heating body may be provided as a heating lamp.

The preheating member may further include a temperature detecting sensor, which detects a temperature of each of the sealing part of the pouch and the pair of sealing blocks, and a controller which stops the preheating of the sealing part of the pouch and the pair of sealing blocks by stopping an operation of each of the first heating body and the second heating body when the temperature detected by the temperature detecting sensor rises to the preheat temperature.

The preheating member may further include a first moving body, which allows the first heating body to move toward the sealing part or return to an initial position, and a second moving body which allows the second heating body to move toward each of the pair of sealing blocks or return to an initial position.

The preheat temperature may be lower than the seal temperature.

A method for manufacturing a secondary battery according to an aspect of the present invention may include: a transfer process of transferring the secondary battery, wherein the secondary battery includes an electrode assembly and a pouch that accommodates the electrode assembly; a disposing process of disposing a pair of sealing blocks at both sides, respectively, of a sealing part formed in the pouch of the secondary battery; a preheating process of preheating, by using a preheating member, to a preheat temperature a surface of each of the sealing part of the pouch and the pair of sealing blocks, which corresponds to the preheating member; and a sealing process of heating to a seal temperature the sealing blocks preheated to the preheat temperature and then compressing and sealing the sealing part of the pouch, which is preheated to the preheat temperature. The preheating process may include preheating the surface of the sealing part, on which the pair of sealing blocks are disposed, to the preheat temperature by a first heating body of the preheating member, and preheating the surface of each of the pair of sealing blocks, which faces the sealing part, to the preheat temperature by a second heating body of the preheating member.

In the preheating process, the preheat temperature of the sealing part preheated by the first heating body and the preheat temperature of the pair of sealing blocks preheated by the second heating body may be the same as or different from each other.

In the preheating process, the preheat when temperature of the sealing part preheated by the first heating body and the preheat temperature of the pair of sealing blocks preheated by the second heating body are different from each other, the preheat temperature of the sealing part preheated by the first heating body may be lower than the preheat temperature of the pair of sealing blocks preheated by the second heating body.

The preheat temperature may be set to 100° C. to 230° C.

A heating lamp may be used as each of the first heating body and the second heating body.

The preheating process may further include detecting a temperature of each of the sealing part of the pouch and the pair of sealing blocks by a temperature detecting sensor, and stopping, by a controller, the preheating of the sealing part of the pouch and the pair of sealing blocks by stopping an operation of each of the first heating body and the second heating body when the temperature detected by the temperature detecting sensor rises to the preheat temperature.

The transfer process may further include a temporarily preheating the sealing part formed in the pouch of the secondary battery during transfer.

### Advantageous Effects

The device and method for manufacturing the secondary battery according to an aspect of the present invention may include the preheating member to heat the sealing part of the pouch and the sealing block to the preheat temperature before the sealing part of the pouch is sealed. Accordingly, the heat loss through the electrode lead may be minimized to increase the sealing force of the sealing part of the pouch from which the electrode lead is drawn out. In particular, the entire sealing part of the pouch from which the electrode lead is drawn out may be uniformly heated, and the temperature of the sealing block may be suppressed from being reduced and becoming mild during the continuous manufacture.

### BRIEF DESCRIPTION OF THE DRAWINGS

FIG. 1 is a perspective view illustrating a secondary battery according to a first embodiment of the present invention.

FIG. 2 is a front view illustrating a device for manufacturing a secondary battery according to a first embodiment of the present invention.

FIG. 3 is a front view illustrating a state in which a sealing part of a pouch is compressed with a sealing block of the device for manufacturing a secondary battery according to the first embodiment of the present invention.

FIG. 4 is a flowchart illustrating a method for manufacturing a secondary battery according to a first embodiment of the present invention.

FIG. 5 is a side view illustrating a transfer process of the method for manufacturing a secondary battery according to the first embodiment of the present invention.

FIG. 6 is a side view illustrating a disposing process and a preheating process of the method for manufacturing a secondary battery according to the first embodiment of the present invention.

FIG. 7 is a side view illustrating a sealing process of the method for manufacturing a secondary battery according to the first embodiment of the present invention.

FIG. 8 is a front view illustrating a device for manufacturing a secondary battery according to a second embodiment of the present invention.

### DETAILED DESCRIPTION

Hereinafter, embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein. The parts unrelated to the description will be ruled out in the drawings in order to clearly describe the present invention. Like reference numerals refer to like elements throughout the whole specification.

### Secondary Battery According to First Embodiment of Present Invention

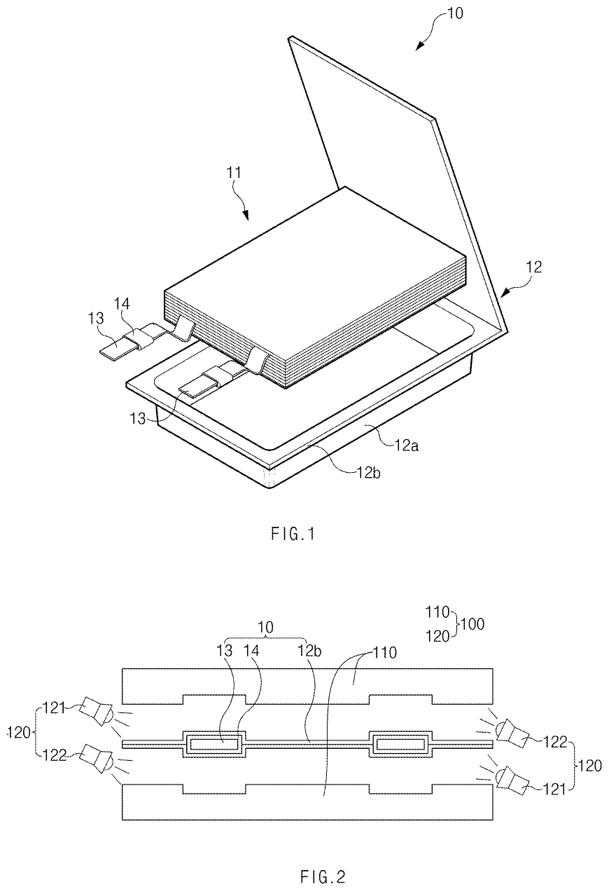

Referring to FIG. 1, a secondary battery 10 according to a first embodiment of the present invention includes an electrode assembly 11, an electrode lead 13 coupled to an electrode tab of the electrode assembly 11, a pouch 12 that accommodates the electrode assembly 11 with a front end of the electrode lead 13 drawn out to the outside thereof, and a lead film 14 provided in the electrode lead 13 disposed on a sealing part of the pouch.

The electrode assembly 11 has a structure in which a plurality of separators and a plurality of electrodes are alternately stacked. The plurality of electrodes may be a positive electrode and a negative electrode. The plurality of electrodes are provided with an electrode tab, and the electrode lead 13 is coupled to the electrode tab.

The electrode tab includes a positive electrode tab provided in the positive electrode, and a negative electrode tab provided in the negative electrode. The electrode lead includes a positive electrode lead coupled to the positive electrode tab and a negative electrode lead coupled to the negative electrode tab.

The pouch 12 includes an accommodation part 12a, which accommodates the electrode assembly 11, and a sealing part 12b which is formed along an edge surface of the accommodation part 12a and seals the accommodation part 12a.

The lead film 14 is intended to increase sealing force between the electrode lead 13 and the sealing part 12b of the pouch 12. That is, the lead film 14 is provided in a shape surrounding a main surface of the electrode lead 13 disposed on the sealing part 12b.

The secondary battery having the structure as above may be manufactured by a device for manufacturing a secondary battery according to a first embodiment of the present invention.

That is, the device 100 for manufacturing a secondary battery according to the first embodiment of the present invention manufactures the secondary battery by accommodating the electrode assembly 11 in the accommodation part 12a of the pouch 12 and then using a pair of sealing blocks 110 to seal the sealing part 12b of the pouch 12.

In particular, the device 100 for manufacturing a secondary battery according to the first embodiment of the present invention may preheat the sealing part 12b of the pouch 12 and the sealing blocks 110 before the sealing part 12b of the pouch 12 is sealed. Accordingly, the sealing force of the sealing part 12b of the pouch 12 from which the electrode lead 13 is drawn out may be increased, and a loss of heat that escapes through the electrode lead may be eliminated or minimized to increase the sealing force.

The device 100 for manufacturing a secondary battery according to the first embodiment of the present invention may also seal the sealing part 12b of the pouch 12, which is not provided with the electrode lead 13, but the sealing part of the pouch from which the electrode lead 13 is drawn out will be described herein as one embodiment.

### Device for Manufacturing Secondary Battery According to First Embodiment of Present Invention

As illustrated in FIG. 1, a device 100 for manufacturing a secondary battery according to a first embodiment of the present invention includes a pair of sealing blocks 110 and a preheating member 120.

### Pair of Sealing Blocks

The pair of sealing blocks 110 are intended to seal a sealing part of a pouch in which an electrode assembly 11 is accommodated. In particular, the pair of sealing blocks 110 are intended to compress and seal the sealing part of the pouch, from which an electrode lead 13 is drawn out, by heat and pressure.

That is, the pair of sealing blocks 110 are disposed to correspond to both sides, respectively, of a sealing part 12b of a pouch 12 from which the electrode lead 13 is drawn out, and compresses and seals the sealing part 12b at a seal temperature and pressure.

Here, the seal temperature refers to a temperature of the heated sealing blocks for thermally fusing the sealing part 12b. For example, the seal temperature may be 190° C. to 230° C.

### Preheating Member

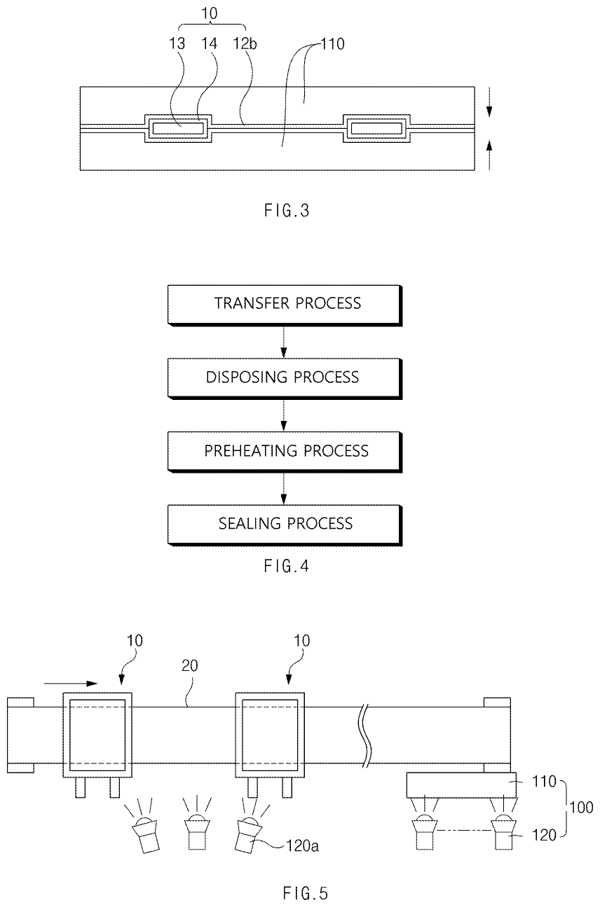

As illustrated in FIGS. 2 and 3, the preheating member 120 is intended to preheat the sealing part 12b of the pouch 12 and the pair of sealing blocks 110 to a preheat temperature before the sealing part of the pouch 12 is sealed. That is, when the sealing part 12b of the pouch 12 and the pair of sealing blocks 110 are preheated to the preheat temperature, the preheating member 120 may suppress a temperature of the sealing blocks from being reduced and becoming mild during the continuous manufacturing. That is, when secondary batteries are continuously sealed through the sealing blocks, a heat source becomes weak and accordingly, a sealing force difference may occur between the secondary batteries produced at the beginning of a sealing process and the secondary batteries produced at each of the middle and the later part of the sealing process. In order to prevent the difference, some embodiments of the present invention may preheat the sealing blocks to prevent the heat source of the sealing blocks from becoming weak and consequently, may uniformly maintain the sealing force in the overall sealing process. Moreover, as the electrode lead 13 is preheated together with the sealing part 12b of the pouch 12, a loss of heat that escapes through the electrode lead 13 may be eliminated or minimized.

In one example, the preheating member 120 includes a first heating body 121 that preheats to the preheat temperature a surface of the sealing part 12b, on which each of the pair of sealing blocks 110 is disposed, and a second heating body 122 that preheats to the preheat temperature a surface of each of the pair of sealing blocks 110, which faces the sealing part 12b.

Accordingly, as the preheating member 120 heats the sealing part 12b of the pouch 12 and the pair of sealing blocks 110 to the preheat temperature, time for which thermal energy required for high sealing force is supplied to the pouch may be reduced to increase productivity. Moreover, as the temperature of the sealing block is suppressed from decreasing during the continuous manufacturing, the secondary batteries having uniform sealing quality may be produced. In order words, the sealing block that is a heat source needs to press the pouch for a long time (e.g., 5 seconds) for strong sealing, and addition of the preheating may minimize the loss of the heat, which escapes the sealing part of the pouch, and time for which the sealing block presses the pouch may be greatly reduced accordingly (e.g., 2 seconds). Consequently, the productivity may be increased due to the reduction of the sealing time and securing of the sealing force (for example, when the sealing time is 5 seconds, 720 secondary batteries (3600S/5S=720) may be produced per hour, and when the sealing time is 2 seconds, 1800 secondary batteries (3600S/2S=1800) may be produced per hour. That is, approximately two-fold increased productivity may be achieved.

In particular, as the electrode lead 13 is preheated together with the sealing part 12b of the pouch 12, the loss of heat that escapes through the electrode lead 13 during sealing the sealing part 12b of the pouch 12 may be prevented or minimized and consequently, the sealing part 12b of the pouch 12 may be improved. Furthermore, the preheating member 120 may minimize the temperature difference of the entire sealing part 12b of the pouch 12 and consequently, the entire sealing part 12b of the pouch 12 may be uniformly sealed to prevent a sealing defect.

The preheat temperature of the sealing part 12b preheated by the first heating body 121 and the preheat temperature of the pair of sealing blocks 110 preheated by the second heating body 122 may be the same as or different from each other.

Here, when the preheat temperature of the sealing part 12b preheated by the first heating body 121 and the preheat temperature of the pair of sealing blocks 110 preheated by the second heating body 122 are the same as each other, the first heating body 121 and the second heating body 122 may heat the sealing part 12b of the pouch 12 and the pair of sealing blocks 110 simultaneously at the same temperature. The same heating body may be used as each of the first heating body 121 and the second heating body 122.

When the preheat temperature of the sealing part 12b preheated by the first heating body 121 and the preheat temperature of the pair of sealing blocks 110 preheated by the second heating body 122 are different from each other, the preheat temperature of the sealing part 12b preheated by the first heating body 121 may be lower than the preheat temperature of the pair of sealing blocks preheated by the second heating body 122. That is, a heating temperature of the sealing part 12b highly likely to be deformed by heat is set to a lower temperature, and a heating temperature of the sealing blocks 110 for sealing the pouch 12 is set to a higher temperature.

The preheat temperature of each of the sealing part and the sealing blocks may be set to 100° C. to 230° C., preferably 150° C. to 200° C. Here, when the preheat temperature of the sealing blocks is 100° C. or lower, it takes much time to raise the preheat temperature of the sealing blocks to the seal temperature. When the preheat temperature of the sealing blocks is 230° C. or higher, it takes less time to raise the preheat temperature of the sealing blocks to the seal temperature, but there is a problem that workability is reduced because it takes much time to raise the temperature of the sealing blocks to the preheat temperature.

A heating lamp may be used as each of the first heating body 121 and the second heating body 122. Accordingly, the entireties of the sealing part 12b of the pouch 12 and the pair of sealing blocks 110 may be stably heated.

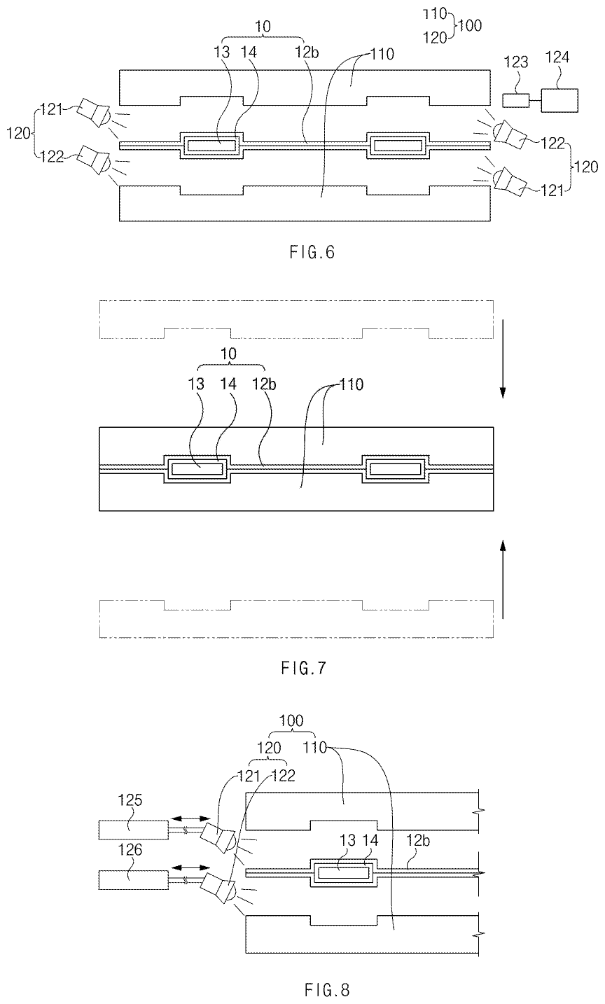

Referring to FIG. 6, the preheating member 120 may further include a temperature detecting sensor 123, which detects the temperature of each of the sealing part 12b of the pouch 12 and the pair of sealing blocks 110, and a controller 124 which stops the preheating of the sealing part 12b of the pouch 12 and the pair of sealing blocks 110 by stopping an operation of each of the first heating body 121 and the second heating body 122 when the temperature detected by the temperature detecting sensor 123 rises to the preheat temperature. Accordingly, as the preheating member 120 includes the temperature detecting sensor 123 and the controller 124, each of the sealing part 12b of the pouch 12 and the pair of sealing blocks 110 may be stably preheated to the preheat temperature.

Thus, as the device 100 for manufacturing a secondary battery according to the first embodiment of the present invention includes the preheating member 120, the sealing force of the sealing part 12b of the pouch 12 from which the electrode lead 13 is drawn out may be increased and the sealing defect may be prevented.

Hereinafter, a method for manufacturing a secondary battery according to a first embodiment of the present invention will be described.

### Method for Manufacturing Secondary Battery According to First Embodiment of Present Invention

As illustrated in FIG. 4, a method for manufacturing a secondary battery according to a first embodiment of the present invention includes a transfer process, a disposing process, a preheating process, and a sealing process.

FIG. 5 is a side view illustrating the transfer process of the method for manufacturing a secondary battery according to the first embodiment of the present invention.

### Transfer Process

In the transfer process, a secondary battery 10 is transferred to the disposing process by a transfer device 20 using a conveyor belt (not shown) or the like. Referring to FIG. 1, the secondary battery 10 includes an electrode assembly 11, an electrode lead 13 coupled to the electrode assembly 11, a pouch 12 that accommodates the electrode assembly 11 with a front end of the electrode lead 13 drawn out to the outside, and a lead film 14 provided in the electrode lead 13 disposed in the pouch 12.

The secondary battery 10 is described above in detail and thus, the detailed description thereof will be omitted.

FIG. 6 is a side view illustrating the disposing process the preheating process of the method for manufacturing a secondary battery according to the first embodiment of the present invention.

### Disposing Process

In the disposing process, each of a pair of sealing blocks 110 is disposed to correspond to each of both sides of a sealing part 12b formed in the pouch 12 of the secondary battery, preferably both sides of the sealing part 12b of the pouch 12 from which the electrode lead 13 is drawn out. Here, each of the pair of sealing blocks 110 is disposed to be spaced a predetermined distance from the sealing part 12b of the pouch 12.

### Preheating Process

In the preheating process, a preheating member 120 is used to heat to a preheat temperature a corresponding surface of each of the sealing part 12b of the pouch 12 and the pair of sealing blocks 110. That is, the preheating process may include preheating the surface of the sealing part 12b, on which each of the pair of sealing blocks 110 is disposed, to the preheat temperature by using a first heating body 121 of the preheating member 120, and preheating the surface of each of the pair of sealing blocks 110, which faces the sealing part 12b, to the preheat temperature by using a second heating body 122 of the preheating member 120.

In the preheating process, the preheat temperature of the sealing part 12b preheated by the first heating body 121 and the preheat temperature of the pair of sealing blocks 110 preheated by the second heating body 122 may be the same as or different from each other.

When the preheat temperature of the sealing part 12b preheated by the first heating body 121 and the preheat temperature of the pair of sealing blocks 110 preheated by the second heating body 122 are different from each other, the preheat temperature of the sealing part 12b preheated by the first body 121 may be lower than the preheat temperature of the pair of sealing blocks 110 preheated by the second heating body 122. As the preheat temperature of the sealing part 12b is set to a temperature lower than that of the sealing block 110, deformation of the sealing part 12b is prevented, and as the preheat temperature of the sealing block 110 is set to a temperature higher than that of the sealing part 12b, time required for raising the temperature to a seal temperature is reduced.

The preheat temperature of each of the sealing part and the sealing block may be set to 100° C. to 230° C., preferably 150° C. to 200° C.

A heating lamp that emits high-temperature light may be used as each of the first heating body 121 and the second heating body 122. Accordingly, the entireties of the sealing part 12b and the sealing block 110 may be stably and uniformly heated to the preheat temperature.

The preheating process may further include detecting the temperature of each of the sealing part 12b of the pouch 12 and the pair of sealing blocks 110 by a temperature detecting sensor 123, and stopping, by a controller 124, the preheating of the sealing part 12b of the pouch 12 and the pair of sealing blocks 110 by stopping an operation of each of the first heating body 121 and the second heating body 122 when the temperature detected by the temperature detecting sensor 123 rises to the preheat temperature. Accordingly, the sealing part 12b of the pouch 12 and the pair of sealing blocks 110 may be stably preheated to the preheat temperature in the preheating process.

FIG. 7 is a side view illustrating the sealing process of the method for manufacturing a secondary battery according to the first embodiment of the present invention.

### Sealing Process

In the sealing process, the pair of sealing blocks 110 are heated to the seal temperature higher than the preheat temperature and then, the sealing part 12b of the pouch 12, which has been preheated to the preheat temperature, are compressed and sealed using the pair of sealing blocks 110. Here, as the pair of sealing blocks 110 seal the preheated pouch, time required for supplying a heat source necessary for the sealing may be greatly reduced. In particular, when the sealing part 12b of the pouch 12 is compressed by the pair of sealing blocks 110, a heat loss may be prevented because the electrode lead 13 drawn out from the sealing part 12b of the pouch is also heated to the preheat temperature. Consequently, a sealing force decrease and a defect of the sealing part 12b of the pouch 12 may be prevented.

That is, as the electrode lead 13 is preheated to the preheat temperature, a temperature different may be minimized between the electrode lead and the pouch 12 heated and compressed by the pair of sealing blocks 110. Accordingly, the loss of heat that escapes through the electrode lead may be eliminated or minimized.

When the processes as above are completed, the secondary battery 10 that is a complete product may be manufactured.

Referring to FIG. 5, the transfer process may further include temporarily preheating the sealing part 12b, which is formed in the pouch 12 of the secondary battery 10 during transfer, by using a temporary heating body 120a. The temporary heating body 120a is provided in plurality to be installed along a transfer line of the secondary battery 10. Accordingly, time required for raising the temperature of the sealing part 12b of the pouch 12 to the preheat temperature in the preheating process may be greatly reduced. Here, in the temporary preheating process, the sealing part 12b of the pouch 12 may be preheated to a temperature lower than the temperature to which the sealing part 12b of the pouch 12 is preheated in the preheating process.

Hereinafter, another embodiment of the present invention will be described using the same reference symbol for the same components as the embodiment described above, and duplicate description will be omitted.

### Device for Manufacturing Secondary Battery According to Second Embodiment of Present Invention

As illustrated in FIG. 8, a device 100 for manufacturing a secondary battery according to a second embodiment of the present invention includes a pair of sealing blocks 110 that are disposed to correspond to both sides, respectively, of a sealing part 12b of a pouch 12 from which an electrode lead 13 is drawn out, and seal the sealing part 12b of the pouch 12 at a seal temperature and pressure, and a preheating member 120 that preheats the sealing part 12b of the pouch 12 and the pair of sealing blocks 110 to a preheat temperature lower than the seal temperature before the sealing part 12b of the pouch 12 is sealed by the pair of sealing blocks 110.

The preheating member 120 includes a first heating body 121, which preheats to the preheat temperature a surface of the sealing part 12b, on which each of the pair of sealing blocks 110 is disposed, and a second heating body 122 which preheats to the preheat temperature a surface of each of the pair of sealing blocks 110, which faces the sealing part 12b.

The preheating member 120 includes a first moving body 125, which moves the first heating body 121 toward the sealing part 12b of the pouch 12 or to an initial position, and a second moving body 126 which moves the second heating body 122 toward each of the pair of sealing blocks 110 or to an initial position. Each of the first moving body 125 and the second moving body 126 may be a cylinder.

Thus, as the first moving body 125 and the second moving body 126 are included, the device 100 for manufacturing a secondary battery according to the second embodiment of the present invention may adjust a distance between the sealing part 12b of the pouch 12 and the first heating body 121, and a distance between each of the pair of sealing blocks 110 and the second heating body 122. Accordingly, the sealing part 12b of the pouch 12 and the pair of sealing blocks may be more uniformly and stably preheated to the preheat temperature.

The scope of the present invention is defined by the appended claims rather than the foregoing description. Various modifications made within the meaning of an equivalent of the claims of the invention and within the claims are to be regarded to be in the scope of the present invention.

### DESCRIPTION OF THE SYMBOLS

10: Secondary battery
11: Electrode assembly
12: Pouch
12a: Accommodation part
12b: Sealing part
13: Electrode lead
14: Lead film
100: Device for manufacturing secondary battery
110: Sealing block
120: Preheating member
121: First heating body
122: Second heating body
123: Temperature detecting sensor
124: Controller
125: First moving body
126: Second moving body

1. A device for manufacturing a secondary battery, the device comprising:
a pair of sealing blocks arranged to face opposing sides, respectively, of a sealing part of a pouch from which an electrode lead protrudes, wherein the pair of sealing blocks is configured to compress and seal the sealing part at a seal temperature and a seal pressure; and
a preheating member configured to preheat the sealing part of the pouch and the pair of sealing blocks,
wherein the preheating member comprises:
a first heating body configured to preheat a surface of the sealing part to a first preheat temperature, and
a second heating body configured to preheat a surface of each of the pair of sealing blocks to a second preheat temperature.

2. The device of claim 1, wherein the first preheat temperature and the second preheat temperature are the same as one another.

3. The device of claim 1, wherein the first preheat temperature and the second preheat temperature are different from each other, the first preheat temperature being lower than the second preheat temperature.

4. The device of claim 1, wherein the first and second preheat temperatures are in a range from 100° C. to 230° C.

5. The device of claim 1, wherein each of the first heating body and the second heating body is a heating lamp.

6. The device of claim 1, wherein the preheating member further comprises:
a temperature detecting sensor configured to detect a first temperature of the sealing part and a second temperature of the pair of sealing blocks; and
a controller configured to stop the preheating of the sealing part and the pair of sealing blocks by stopping an operation of each of the first heating body and the second heating body when the first and second temperatures detected by the temperature detecting sensor are the same as the respective first and second preheat temperatures.

7. The device of claim 1, wherein the preheating member further comprises:
a first moving body configured to move the first heating body toward the sealing part or return the first heating body to an initial position of the first heating body; and
a second moving body configured to move the second heating body toward the pair of sealing blocks or return the second heating body to an initial position of the second heating body.

8. The device of claim 1, wherein the first preheat temperature is lower than the seal temperature.

9. A method for manufacturing a secondary battery, the method comprising:
transferring the secondary battery in a transfer process, wherein the secondary battery comprises an electrode assembly and a pouch accommodating the electrode assembly;
disposing a pair of sealing blocks facing opposing sides, respectively, of a sealing part of the pouch of the secondary battery in a disposing process;
preheating a surface of opposing sides of the sealing part of the pouch to a first preheat temperature and a surface of each of the pair of sealing blocks to a second preheat temperature in a preheating process, by using a preheating member; and
heating the pair of sealing blocks to a sealing temperature and then compressing and sealing the sealing part of the pouch with the pair of sealing blocks in a sealing process,
wherein the preheating process comprises:
preheating the surface of the opposing sides of the sealing part to the first preheat temperature by a first heating body of the preheating member, and
preheating the surface of each of the pair of sealing blocks to the second preheat temperature by a second heating body of the preheating member.

10. The method of claim 9, wherein, in the preheating process, the first preheat temperature and the second preheat temperature are the same as one another.

11. The method of claim 9, wherein, in the preheating process, the first preheat temperature and the second preheat temperature are different from each other, the first preheat temperature being lower than the second preheat temperature.

12. The method of claim 9, wherein the first and second preheat temperatures are in a range from 100° C. to 230° C.

13. The method of claim 9, wherein each of the first heating body and the second heating body is a heating lamp.

14. The method of claim 9, wherein the preheating process further comprises:
detecting a first temperature of the sealing part and detecting a second temperature of the pair of sealing blocks by a temperature detecting sensor; and
stopping, by a controller, the preheating by stopping an operation of each of the first heating body and the second heating body when the first and second temperatures detected by the temperature detecting sensor are the same as the respective first and second preheat temperatures.

15. The method of claim 9, wherein the transfer process further comprises temporarily preheating the sealing part during transfer.

16. The device of claim 1, wherein the second preheat temperature is lower than the seal temperature.
